(19) United States
(12) Patent Application Publication
(10) Pub. No.: US 2024/0138030 A1
(43) Pub. Date: Apr. 25, 2024

(54) ELECTROTHERMAL MODULE

(71) Applicant: TAIWAN TEXTILE RESEARCH INSTITUTE, NEW TAIPEI CITY (TW)

(72) Inventors: Hou-Sheng HUANG, NEW TAIPEI CITY (TW); Chien-Lung SHEN, NEW TAIPEI CITY (TW); Shu-Chu TSAI, NEW TAIPEI CITY (TW); Hung-Yu LIN, NEW TAIPEI CITY (TW)

(21) Appl. No.: 18/475,356

(22) Filed: Sep. 26, 2023

(30) Foreign Application Priority Data
Oct. 19, 2022 (TW) 111139824

(51) Int. Cl. H05B 3/34; H05B 3/14

(52) U.S. Cl. CPC H05B 3/342; H05B 3/145; H05B 2203/01; H05B 2203/036

(57) ABSTRACT

An electrothermal module includes a first conductive layer, a second conductive layer, and a heat generating layer. The first conductive layer and the second conductive layer respectively include silver metal. The heat generating layer has a first portion, the first portion is disposed between the first conductive layer and the second conductive layer to form an electrothermal conversion portion of the electrothermal module, and the heat generating layer includes a conductive carbon material.

### CROSS-REFERENCE TO RELATED APPLICATION

This application claims priority to Taiwan Application Serial Number 111139824, filed Oct. 20, 2022, which is herein incorporated by reference.

### BACKGROUND

### Field of Invention

The present disclosure relates to an electrothermal module, and particularly relates to an electrothermal module for textile field.

### Description of Related Art

In recent years, the global greenhouse effect has caused extreme climate change, and the extremely cold and extremely hot climate has also changed the style of clothing, making traditional clothing gradually introduce technology to strengthen the function of keeping warm. Nowadays, most electronic components are connected to clothing by means of external hanging, but this method is prone to problems of poor compatibility and significant foreign body sensation. If the electronic components are directly attached to the clothing, the flexibility and stretchability of the electronic components also need to be considered, and the existing manufacturing process often leads to the problems of low thermal uniformity and low heat generating efficiency in the heating area of the electronic components. Therefore, how to take into account the heat generating performance and comfort of electronic clothing is currently an important issue in the electronic clothing industry.

### SUMMARY

The present disclosure provides an electrothermal module which can achieve high thermal uniformity and high heat generating efficiency at low power.

According to some embodiments of the present disclosure, an electrothermal module includes a first conductive layer, a second conductive layer, and a heat generating layer. The first conductive layer and the second conductive layer respectively include silver metal. The heat generating layer has a first portion, the first portion is disposed between the first conductive layer and the second conductive layer to form an electrothermal conversion portion of the electrothermal module, and the heat generating layer includes a conductive carbon material.

In some embodiments of the present disclosure, the heat generating layer further includes a second portion connected to the electrothermal conversion portion adjacent to the second portion, and the second portion of the heat generating layer is a plurality of heat generating portions.

In some embodiments of the present disclosure, the electrothermal conversion portion and anyone of the heat generating portions are connected to each other by the first portion and the second portion of the heat generating layer.

In some embodiments of the present disclosure, a distribution density of the heat generating portions ranges from 90 pieces/150 cm² to 110 pieces/150 cm².

In some embodiments of the present disclosure, a thickness of the first conductive layer and a thickness of the second conductive layer are respectively between 10 μm and 50 μm, and a thickness of the heat generating layer is between 20 μm and 100 μm.

In some embodiments of the present disclosure, a sum of a thickness of the first conductive layer and a thickness of the second conductive layer is the same as a thickness of the heat generating layer.

In some embodiments of the present disclosure, the first conductive layer and the second conductive layer respectively include an oil-based rubber, and a solid content of the silver metal in the oil-based rubber is between 60 wt % and 70 wt %.

In some embodiments of the present disclosure, the heat generating layer includes an oil-based rubber, and a solid content of the conductive carbon material in the oil-based rubber is between 25 wt % and 30 wt %.

In some embodiments of the present disclosure, the conductive carbon material is composed of 60 parts by weight to 70 parts by weight of a carbon black and 40 parts by weight to 30 parts by weight of a graphite.

In some embodiments of the present disclosure, the electrothermal module further includes a flexible substrate carrying the electrothermal conversion portion, in which a vertical projection of the heat generating layer on the flexible substrate completely overlaps a vertical projection of the first conductive layer and the second conductive layer on the flexible substrate.

According to the aforementioned embodiments of the present disclosure, since the electrothermal module of the present disclosure includes a heat generating layer and a first conductive layer and a second conductive layer disposed on two opposite surfaces of the heat generating layer, and the heat generating layer, the first conductive layer, and the second conductive layer respectively include suitable materials, the electric heating module can achieve high thermal uniformity and high heat generating efficiency at low power.

### BRIEF DESCRIPTION OF THE DRAWINGS

The disclosure can be more fully understood by reading the following detailed description of the embodiments, with reference made to the accompanying drawings as follows:

FIG. 1 is a schematic top view illustrating an electrothermal module according to some embodiments of the present disclosure;

FIG. 2A is a schematic cross-sectional view of the electrothermal module shown in FIG. 1 taken along line 2A-2A; and

FIG. 2B is a schematic cross-sectional view of the electrothermal module shown in FIG. 1 taken along line 2B-2B.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The present disclosure provides an electrothermal module which includes a heat generating layer and two conductive layers disposed on opposite surfaces of the heat generating layer. By disposing the heat generating layer between the two conductive layers and making the heat generating layer and the conductive layer respectively include suitable materials, the electrothermal module can achieve high thermal uniformity and high heat generating efficiency at low power.

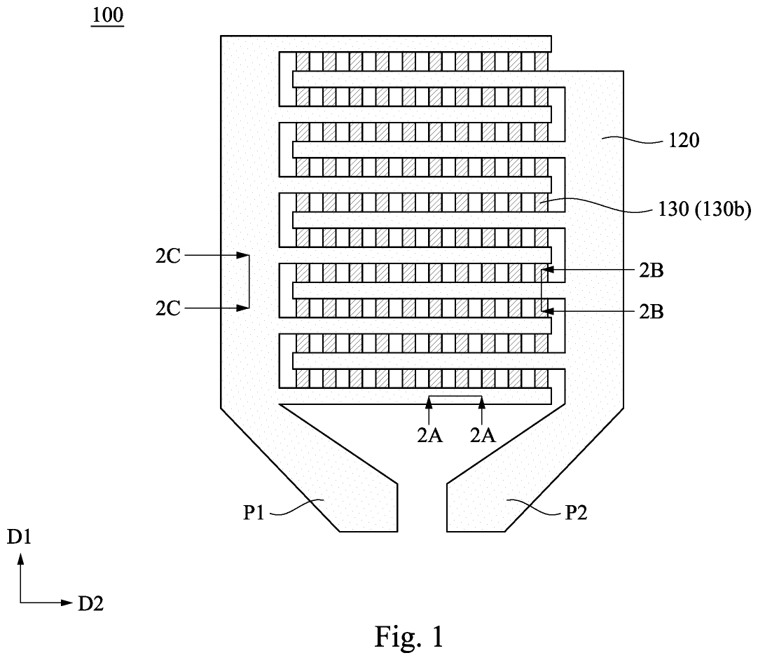

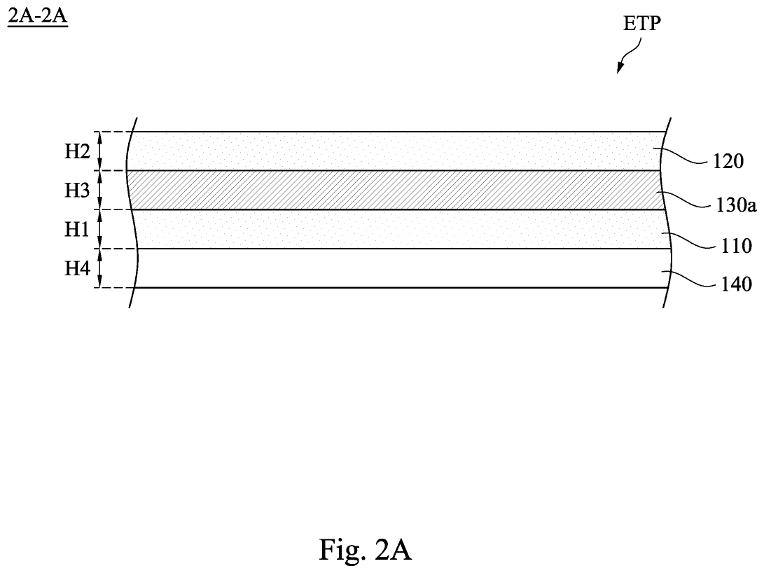

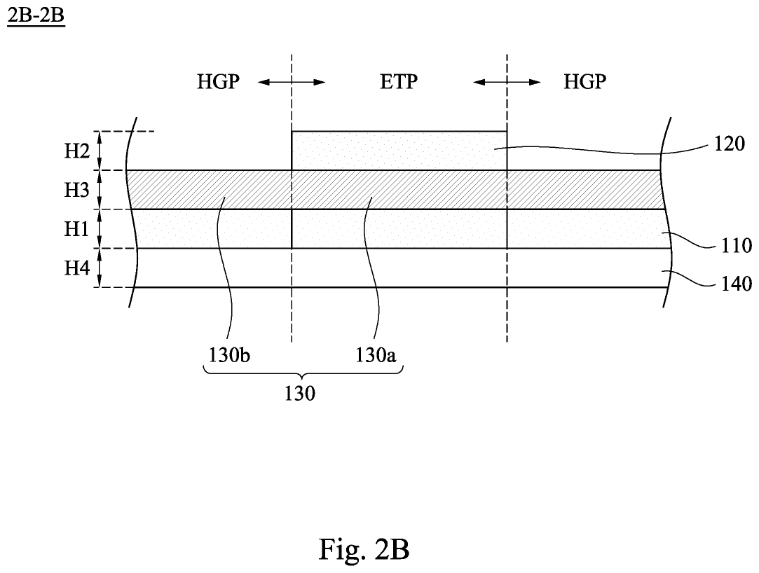

FIG. 1 is a schematic top view illustrating an electrothermal module 100 according to some embodiments of the present disclosure. FIG. 2A is a schematic cross-sectional view of the electrothermal module 100 shown in FIG. 1 taken along line 2A-2A. Reference is made to FIG. 1 and FIG. 2A. The electrothermal module 100 includes a first conductive layer 110, a second conductive layer 120, and a heat generating layer 130. In some embodiments, the first conductive layer 110 and the second conductive layer 120 may be configured to provide a path for electron transfer, and the heat generating layer 130 may be configured to provide thermal energy. The first conductive layer 110 and the second conductive layer 120 respectively include silver metal to provide high conductivity. The heat generating layer 130 includes a conductive carbon material to provide high heat generating performance. The heat generating layer 130 has a first portion 130a, and the first portion 130a of the heat generating layer 130 is disposed between the first conductive layer 110 and the second conductive layer 120 to form an electrothermal conversion portion ETP of the electrothermal module 110. In other words, the electrothermal conversion portion ETP of the electrothermal module 110 includes the first conductive layer 110, the first portion 130a of the heat generating layer 130, and the second conductive layer 120 that are stacked in sequence. In some embodiments, the electrothermal conversion portion ETP may be configured to convert electrical energy into thermal energy. In some embodiments, the electrothermal module 100 may include a first pin P1 and a second pin P2, and the first pin P1 and the second pin P2 may be electrically connected to the positive electrode and negative electrode of a power source (e.g., a battery), respectively. It should be understood that, since in FIG. 1, the cross section taken along line 2A-2A and the cross section taken along line 2C-2C shows the same laminated structure, the cross section taken along line 2C-2C will not further be illustrated in the present disclosure.

FIG. 2B is a schematic cross-sectional view of the electrothermal module 100 shown in FIG. 1 taken along line 2B-2B. Reference is made to FIG. 1 and FIG. 2B. In some embodiments, the heat generating layer 130 may further include a second portion 130b, the second portion 130b of the heat generating layer 130 is connected to the adjacent electrothermal conversion portion ETP, and the second portion 130b of the heat generating layer 130 may be a plurality of heat generating portions HGP. In some embodiments, the heat generating portions HGP may be configured to enable the electrothermal module 100 to stably supply thermal energy. In some embodiments, the electrothermal conversion portion ETP and anyone of the heat generating portions HGP may be connected to each other by the first portion 130a and the second portion 130b of the heat generating layer 130, and the first portion 130a and the second portion 130b of the heat generating layer 130 may have an integrally formed structure, such that the electrothermal module 100 has good structural stability. In general, during the operation of the electrothermal module 100, current can enter the electrothermal conversion portion ETP through the first pin P1, and conduct electrothermal conversion in the electrothermal conversion portion ETP at the interface between the first conductive layer 110 and the heat generating layer 130 and the interface between the second conductive layer 120 and the heat generating layer 130. The generated thermal energy can then be transferred to the outside environment (e.g., the user's body) by the heat generating layer 130 of the heat generating portion HGP, such that the electrothermal module 100 can stably supply thermal energy.

It is worth noting that, compared with many conventional electrothermal modules currently on the market that only have a single heat generating layer and a single conductive layer, the electrothermal module 100 of the present disclosure includes the first conductive layer 110 and the second conductive layer 120 disposed on opposite surfaces of the heat generating layer 130. Hence, the interface resistance between the first and second conductive layers 110 and 120 and the heat generating layer 130 in the electrothermal module 100 of the present disclosure is relatively low (i.e., the overall electrical resistance of the electrothermal module 100 of the present disclosure is relatively low). However, compared with the conventional electrothermal module, the electrothermal module 100 of the present disclosure can provide better thermal uniformity and better heat generating efficiency, and compared with the electrothermal module which needs to achieve the expected temperature and thermal uniformity under high power, the electrothermal module 100 of the present disclosure can achieve the expected temperature and thermal uniformity under low power.

In some embodiments, the heat generating portions HGP and the electrothermal conversion portions ETP can be arranged alternately, such that each heat generating portions HGP can continuously and stably supply heat energy. Taking the electrothermal module 100 of FIG. 1 as an example, the heat generating portions HGP and the electrothermal conversion portions ETP may be alternately arranged in the first direction D1. In some embodiments, the heat generating portions HGP can be arranged in an array to take into account both material cost and heat generating uniformity. Taking the electrothermal module 100 of FIG. 1 as an example, the heat generating portions HGP may be arranged in an array in the first direction D1 and the second direction D2. In some embodiments, a distribution density of the heat generating portions HGP can be between 90 pieces/150 cm² to 110 pieces/150 cm², so as to provide sufficient heat generating points per unit area, such that the electrothermal module 100 can achieve the expected temperature and thermal uniformity under low power. In detail, if the distribution density of the heat generating portions is less than 90 pieces/150 cm², it may take a long time for the electrothermal module 100 to reach the expected temperature and thermal uniformity; if the distribution density of the heat generating portions is greater than 110 pieces/150 cm², it may cause the overall temperature of the electrothermal module 100 to be high and reduce wearing comfort.

The present disclosure can further improve the thermal uniformity and the heat generating efficiency of the electrothermal module 100 by adjusting the respective thicknesses of the first conductive layer 110, the second conductive layer 120, and the heat generating layer 130, while taking into account the material cost. In some embodiments, the thickness H1 of the first conductive layer 110 and the thickness H2 of the second conductive layer 120 may respectively be between 10 μm and 50 μm, and the thickness H3 of the heat generating layer 130 may be between 20 μm and 100 μm. In detail, since the first conductive layer 110, the second conductive layer 120, and the heat generating layer 130 can be formed by screen printing, for example, if the thickness H1 of the first conductive layer 110 and the thickness H2 of the second conductive layer 120 are respectively less than 10 μm, and the thickness H3 of the heat generating layer 130 is less than 20 μm, it may cause the material density of the above-mentioned stack to be low, making it difficult to further improve the thermal uniformity and heat generating efficiency of the electrothermal module 100. On the contrary, if the thickness H1 of the first conductive layer 110 and the thickness H2 of the second conductive layer 120 are respectively greater than 50 μm, and the thickness H3 of the heat generating layer 130 is greater than 100 μm, materials may be wasted, manufacturing costs may be increased, and the flexibility of the electrothermal module 100 may be reduced.

The present disclosure can further improve the thermal uniformity and heat generating efficiency of the electrothermal module 100 by adjusting the respective material formulations of the first conductive layer 110 and the second conductive layer 120, such that the electrothermal module 100 is more suitable for applications in the textile field such as wearing clothing. In some embodiments, the first conductive layer 110 and the second conductive layer 120 may respectively include an oil-based rubber, and the oil-based rubber may be, for example, neoprene, such that the first conductive layer 110 and the second conductive layer 120 have good bending resistance. It is worth noting that the oil-based rubber has better washing fastness than polyurethane and epoxy resin, and the oil-based rubber has better adhesion and lower material cost than silicone rubber. In some embodiments, a solid content of the respective silver metal in the first conductive layer 110 and the second conductive layer 120 in the oil-based rubber may be between 60 wt % and 70 wt %, such that both the conductivity and coating uniformity of the first conductive layer 110 and the second conductive layer 120 and the wearing applications of the electrothermal module 100 can be taken into account. In detail, if the solid content of the silver metal in the oil-based rubber is greater than 70 wt %, the slurry used for forming the first conductive layer 110 and the second conductive layer 120 may provide poor coating uniformity, and the wearing comfort of the electrothermal module 100 may be reduced; If the solid content of the silver metal in the oil-based rubber is less than 60 wt %, it may affect the transferring path of the electrons as well as the interface resistance between the first and second conductive layers 110 and 120 and the heat generating layer 130, resulting in difficulties to further improve the thermal uniformity and heat generating efficiency of the electrothermal module 100.

The present disclosure can further improve the thermal uniformity and heat generating efficiency of the electrothermal module 100 by adjusting the material formulations of the heat generating layer 130, such that the electrothermal module 100 is more suitable for applications in the textile field such as wearing clothing. In some embodiments, the heat generating layer 130 may include an oil-based rubber, and the oil-based rubber may be neoprene, for example, to provide advantages such as good bending resistance, good washing fastness, good adhesion, and low material cost. In some embodiments, a solid content of the conductive carbon material in the heat generating layer 130 in the oil-based rubber can be between 25 wt % and 30 wt %, so as to take into account the heat generating performance and coating performance of the heat generating layer 130 as well as the wearing applications of the electrothermal module 100. In detail, if the solid content of the conductive carbon material in the oil-based rubber is greater than 30 wt %, the slurry used for forming the first conductive layer 110 and the second conductive layer 120 may provide poor coating uniformity, and the wearing comfort of the electrothermal module 100 may be reduced; If the solid content of the conductive carbon material in the oil-based rubber is less than 25 wt %, it may affect the heat generating performance of the heat generating layer 130 as well as the interface resistance between the first and second conductive layers 110 and 120 and the heat generating layer 130, resulting in difficulties to further improve the thermal uniformity and heat generating efficiency of the electrothermal module 100. In some embodiments, the conductive carbon material is composed of 60 parts by weight to 70 parts by weight of a carbon black and 40 parts by weight to 30 parts by weight of a graphite, such that the heat generating layer 130 can provide both good electrical conductivity and thermal conductivity. Also, the electrothermal conversion efficiency, thermal uniformity, and heat generating efficiency of the electrothermal module 100 are improved.

In some embodiments, the electrothermal module 100 may further include a flexible substrate 140, the flexible substrate 140 is configured to carry (support) the electrothermal conversion portion ETP and the heat generating portion HGP, and is disposed on the surface of the first conductive layer 110 or the second conductive layer 120 facing away from the heat generating layer 130, such that the electrothermal module 100 can be disposed on textiles such as wearing clothing. In some embodiments, the material of the flexible substrate 140 may include polyurethane (PU), thermoplastic polyurethane (TPU), polyimide (PI), or polyethylene terephthalate (PET) to provide the electrothermal module 100 with good support and softness, such that the wearing comfort of the electrothermal module 100 is improved, and the adhesion between the flexible substrate 140 and the first conductive layer 110 or the second conductive layer 120 can be good. In some embodiments, the thickness H4 of the flexible substrate 140 may be between 50 μm and 100 μm, so as to reduce the foreign body sensation when the electrothermal module 100 is disposed on the textile. In some embodiments, a vertical projection of the heat generating layer 130 on the flexible substrate 140 may completely overlap a vertical projection of the first conductive layer 110 and the second conductive layer 120 on the flexible substrate 140. In this way, the current flowing through the first conductive layer 110 and the second conductive layer 120 can efficiently perform electrothermal conversion at the interface between the first conductive layer 110 and the heat generating layer 130 and the interface between the second conductive layer 120 and the heat generating layer 130. Thus, the electrothermal conversion efficiency, thermal uniformity, and heat generating efficiency of the electrothermal module 100 are improved. In some embodiments, the contour of the flexible substrate 140 can conform to the contour of the first conductive layer 110, the second conductive layer 120, and the heat generating layer 130, such that the electrothermal module 100 can be well bent or stretch according to the shape of textile.

It should be understood that the connection relationships and the functions of the components that have been described will not be repeated hereinafter. In the following description, various tests and evaluations will be performed on the electrothermal module 100 of multiple embodiments and multiple comparative examples to further verify the efficacy of the present disclosure. It should be understood that the materials used, their amounts and proportions, processing details, and processing procedures may be appropriately changed without departing from the scope of the present disclosure. Therefore, the present disclosure should not be limited by the electrothermal module of the embodiments described below.

### <Experiment 1: Thermal Uniformity Test and Heat Generating Efficiency Test of Electrothermal Module>

In this experiment, the thermal uniformity test and the heat generating efficiency test were carried out for the electrothermal modules of each embodiment and each comparative example. In the electrothermal module of each embodiment and each comparative example, a hundred heat generating points (heat generating portions) were provided at equal intervals in an area of 10 cm×15 cm.

The thermal uniformity test was carried out according to the FTTS-GA-178 standard method by taking 12 heat generating points on the surface of the electrothermal module, then measuring the temperature of each heat generating point, and then subtracting the lowest temperature from the highest temperature and divide it by the highest temperature, so as to obtain the temperature difference (expressed as a percentage) between the heat generating points. The heat generating efficiency test was carried out according to the FTTS-GA-178 standard method by taking 12 heat generating points on the surface of the electrothermal module, then measuring the temperature of each heat generating point, and then calculating the average temperature of all heat generating points to obtain the average temperature of the heat generating points. The working voltage of the electrothermal modules of each embodiment and each comparative example is 5V. The detailed description and test results of the electrothermal modules of each embodiment and each comparative example are shown in Table 1.

TABLE 1

| | | | | temperature | average |
|---|---|---|---|---|---|
| | thickness of | thickness of | thickness of | difference | temperature |
| | first | heat | second | between heat | of heat |
| | conductive | generating | conductive | generating | generating |
| | layer (μm) | layer (μm) | layer (μm) | points (%) | points (° C.) |
| Embodiment 1 | 10 | 20 | 10 | 19.26 | 46.20 |
| Embodiment 2 | 50 | 20 | 10 | 19.99 | 47.40 |
| Embodiment 3 | 50 | 20 | 50 | 28.37 | 46.10 |
| Embodiment 4 | 50 | 100 | 10 | 24.15 | 48.32 |
| Embodiment 5 | 50 | 100 | 50 | 16.80 | 47.10 |
| Comparative | 50 | 20 | N/A | 31.48 | 41.93 |
| Example 1 | | | | | |
| Comparative | 30 | 100 | N/A | 30.04 | 45.91 |
| Example 2 | | | | | |
| Comparative | 50 | 100 | N/A | 43.64 | 40.17 |
| Example 3 | | | | | |

It can be seen from Table 1 that regarding the temperature difference between the heat generating points, the temperature difference of each embodiment is smaller than the temperature difference of each comparative example, and therefore, it can be seen that the configuration of two conductive layers can indeed help improve the thermal uniformity of the electrothermal module; regarding the average temperature of the heat generating points, the average temperature of each embodiment is greater than the average temperature of each comparative example, and therefore, it can be seen that the configuration of two conductive layers is indeed helpful to improve the heat generating efficiency of the electrothermal module. It is worth noting that the temperature difference between the heat generating points of the electrothermal module of each embodiment is less than 30%, and the average temperature of the heat generating points of the electrothermal module of each embodiment is greater than 46° C., showing excellent thermal uniformity and excellent heat generating efficiency. On the other hand, in the electrothermal module of each embodiment, when the sum of the thickness of the first conductive layer and the thickness of the second conductive layer is the same as the thickness of the heat generating layer, the electrothermal module can provide better thermal uniformity.

### <Experiment 2: Washing Fastness of Electrothermal Module>

In this experiment, the electrothermal modules of Embodiments 1 to 5 were washed continuously for 30 times according to the AATCC 135 standard method, and the electrothermal modules of Embodiments 1 to 5 were operated at a working voltage of 5V after washing, and the average temperature (° C.) of the aforementioned 12 heat generating points was measured at the 60^{th} second, the 300^{th} second, and the 600^{th} second for the electrothermal modules of Embodiments 1 to 5. The test results are shown in Table 2.

TABLE 2

| | the 60^{th} | the 300^{th} | the 600^{th} |
|---|---|---|---|
| | second | second | second |
| Embodiment 1 | 35.09 | 38.00 | 39.70 |
| Embodiment 2 | 38.22 | 41.70 | 45.90 |
| Embodiment 3 | 37.54 | 40.50 | 41.70 |
| Embodiment 4 | 37.89 | 41.70 | 43.10 |
| Embodiment 5 | 40.88 | 44.80 | 46.70 |
| average temperature | 37.92 | 41.34 | 43.42 |

It can be seen from Table 2 that at the 300^{th} second, the average temperature of the electrothermal modules of Embodiments 1 to 5 is higher than 40° C., and at the 600th second, the average temperature of the electrothermal modules of Embodiments 1 to 5 can be recovered to 43.42° C. It can be seen that the electrothermal module of the present disclosure can have good washing fastness, so as to be suitable for disposing on textiles such as wearing clothing, and can have a long service life.

According to the aforementioned embodiments of the present disclosure, since the electrothermal module of the present disclosure includes a heat generating layer and a first conductive layer and a second conductive layer disposed on two opposite surfaces of the heat generating layer, and the heat generating layer, the first conductive layer, and the second conductive layer respectively include suitable materials, the electric heating module can achieve high thermal uniformity and high heat generating efficiency at low power. In addition, by adjusting the respective thicknesses and material formulations of the first conductive layer, the second conductive layer, and the heat generating layer, the thermal uniformity and heat generating efficiency of the electrothermal module can be further improved, and the electrothermal module can be more suitable for applications in the textile field such as wearing clothing.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. An electrothermal module, comprising:
a first conductive layer and a second conductive layer respectively comprising silver metal; and
a heat generating layer having a first portion disposed between the first conductive layer and the second conductive layer to form an electrothermal conversion portion of the electrothermal module, wherein the heat generating layer comprises a conductive carbon material.

2. The electrothermal module of claim 1, wherein the heat generating layer further comprises a second portion connected to the electrothermal conversion portion adjacent to the second portion, and the second portion of the heat generating layer is a plurality of heat generating portions.

3. The electrothermal module of claim 2, wherein the electrothermal conversion portion and anyone of the heat generating portions are connected to each other by the first portion and the second portion of the heat generating layer.

4. The electrothermal module of claim 2, wherein a distribution density of the heat generating portions ranges from 90 pieces/150 cm² to 110 pieces/150 cm².

5. The electrothermal module of claim 1, wherein a thickness of the first conductive layer and a thickness of the second conductive layer are respectively between 10 μm and 50 μm, and a thickness of the heat generating layer is between 20 μm and 100 μm.

6. The electrothermal module of claim 1, wherein a sum of a thickness of the first conductive layer and a thickness of the second conductive layer is the same as a thickness of the heat generating layer.

7. The electrothermal module of claim 1, wherein the first conductive layer and the second conductive layer respectively comprise an oil-based rubber, and a solid content of the silver metal in the oil-based rubber is between 60 wt % and 70 wt %.

8. The electrothermal module of claim 1, wherein the heat generating layer comprises an oil-based rubber, and a solid content of the conductive carbon material in the oil-based rubber is between 25 wt % and 30 wt %.

9. The electrothermal module of claim 1, wherein the conductive carbon material is composed of 60 parts by weight to 70 parts by weight of a carbon black and 40 parts by weight to 30 parts by weight of a graphite.

10. The electrothermal module of claim 1, further comprising:
a flexible substrate carrying the electrothermal conversion portion, wherein a vertical projection of the heat generating layer on the flexible substrate completely overlaps a vertical projection of the first conductive layer and the second conductive layer on the flexible substrate.
